(19) United States
(12) Patent Application Publication
(10) Pub. No.: US 2016/0173397 A1
(43) Pub. Date: Jun. 16, 2016

(54) COMMUNICATION CONTROL DEVICE, METHOD OF COMMUNICATING A FRAME, AND STORAGE MEDIUM

(71) Applicant: FUJITSU LIMITED, Kawasaki-shi (JP)

(72) Inventors: Jun YAJIMA, Kawasaki (JP); Masahiko TAKENAKA, Kawasaki (JP)

(73) Assignee: FUJITSU LIMITED, Kawasaki (JP)

(21) Appl. No.: 14/954,020

(22) Filed: Nov. 30, 2015

(30) Foreign Application Priority Data
Dec. 16, 2014 (JP) 2014-254545

(51) Int. Cl. H04L 12/833; H04L 12/947; H04L 12/823

(52) U.S. Cl. CPC H04L 47/31; H04L 47/32; H04L 49/252

(57) ABSTRACT

A communication control device includes ports, a memory, a processor, and a selector. The memory stores one or more pieces of identification information correlated with each of ports, the one or more pieces of identification information being included in a frame for transmission of the frame by communication devices each coupled to the ports. The processor generates a second frame in which is set second identification information regarding which determination will be made at the communication devices that the frame is to be discarded, when first identification information in a first frame received at a first port of the ports is not stored in the memory correlated with the first port. The selector selects only the second frame from among the first frame and the second frame when the first frame and the second frame are input, and outputs the selected second frame to the ports.

### CROSS-REFERENCE TO RELATED APPLICATION

This application is based upon and claims the benefit of priority of the prior Japanese Patent Application No. 2014-254545, filed on Dec. 16, 2014, the entire contents of which are incorporated herein by reference.

### FIELD

The present embodiment relates to control of communication between communication devices.

### BACKGROUND

There are cases where a network technology called Controller Area Network (CAN) is used to transmit/receive data and control information between devices used in an automobile onboard network, factory automation, and so forth. In CAN technology, a CAN hub may be used to couple devices called electronic control units (ECU).

FIG. 1 illustrates an example of transmission/reception of frames in a system including a CAN hub 10. In the example in FIG. 1, ECUs 5 (5a, 5b, and 5c) are coupled to the CAN hub 10. The CAN hub 10 outputs signals input from a certain port to all ports, via CAN transceivers 11 (11a, 11b, and 11c) and a communication arbitration unit 12. In a case where multiple frames are transmitted at the same time, the communication arbitration unit 12 decides a frame to be output. Frames used for communication include identification information (ID). Each ECU stores identification information of frames to be received, beforehand.

For example, an arrangement will be assumed where the ECU 5b receives a frame with ID “789”, and the ECU 5c receives a frame with ID “123”. The ECU 5a is set to transmit a frame with ID “123” or ID “456”. For example in a case where the ECU 5a transmits a frame F1 regarding which an ID of 123 has been specified, the frame F1 is output from all ports that the CAN hub 10 has, so the frame F1 is output toward all of the ECUs 5a through 5c, as illustrated in FIG. 1. The frame ID for reception at the ECU 5b is 789, so the ECU 5b discards the frame F1. The frame ID for reception at the ECU 5c is 123, so the ECU 5a receives the frame F1, and performs processing as appropriate.

FIG. 2 illustrates an example of a case where transmission processing is performed using an ID not set as an ID for use in transmission processing. Assumption will be made regarding an example where the ECU 5a has been externally attacked, and thus has transmitted a frame F2 in which is set an ID “789” which is not set as an ID to be used for transmission processing. The frame F2 is also output from all ports, and accordingly the frame F2 is transmitted toward the ECUs 5a through 5c. The ECU 5b set to receive the frame with ID “789” receives the frame F2, but the ECU 5c discards the frame F2. Thus, due to the ID used for transmission processing by the ECU 5a having been changed, the ECU 5b receives the frame from the ECU 5a which the ECU 5b originally is not intended to receive, as the frame F2, and performs the processing of the frame F2. In this way, the frame F2, including data which originally is not intended to be processed at the ECU 5b, is processed by the ECU 5b, which may lead to system problems.

Technology has been conceived to avoid the ECUs 5 from receiving such unauthorized frames. For example, a proposal has been made to correlate the ports of the CAN hub 10 with the IDs that the ECUs 5 coupled thereto use for transmission, and to cut the wiring between the port where the frame including the uncorrelated ID has been input and the communication arbitration unit 12, using a switch. There also has been proposed as related art an automobile onboard communication system that stops transmitting data when detecting continuous data transmission by the same source for a predetermined amount of time or longer.

There is known a related art where a pseudo transmission-failed state is generated at a device regarding which data transmission is to be suppressed, and thereafter communication is performed between devices regarding which data transmission is not to be suppressed, thereby giving priority to communication among particular devices. There is also known a related art where, at the time of output particular data that passes through a gateway device, dummy data that does not pass through the gateway device is also output, thereby relaying the data in a sure manner.

As examples of related art, Japanese Laid-open Patent Publication Nos. 2004-363761 and 2014-36417, and Sekiguchi Daiki et al., “White-List Hub: A Network Component to Suppress Unauthorized CAN Data Transmission”, Proceedings of the Symposium on Cryptography and Information Security SCIS 2014, The Institute of Electronics, Information and Communication Engineers, January 2014, SCIS 2014-2-C1-1 are known.

### SUMMARY

According to an aspect of the invention, a communication control device including a plurality of ports, the communication control device includes: a memory configured to store one or more pieces of identification information correlated with each of one or more of the plurality of ports to which a communication device has been coupled, the one or more pieces of identification information being included in a frame for transmission of the frame by one or more communication devices each coupled to the one or more ports; a processor configured to generate a second frame in which is set second identification information regarding which determination will be made at the one or more communication devices that the frame is to be discarded, when first identification information in a first frame received at a first port of the one or more ports is not stored in the memory correlated with the first port; and a selector configured to: select only the second frame from among the first frame and the second frame when the first frame and the second frame are input, and output the selected second frame to the plurality of ports.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of transmission/reception of frames that is performed in a system including a controller area network (CAN) hub;

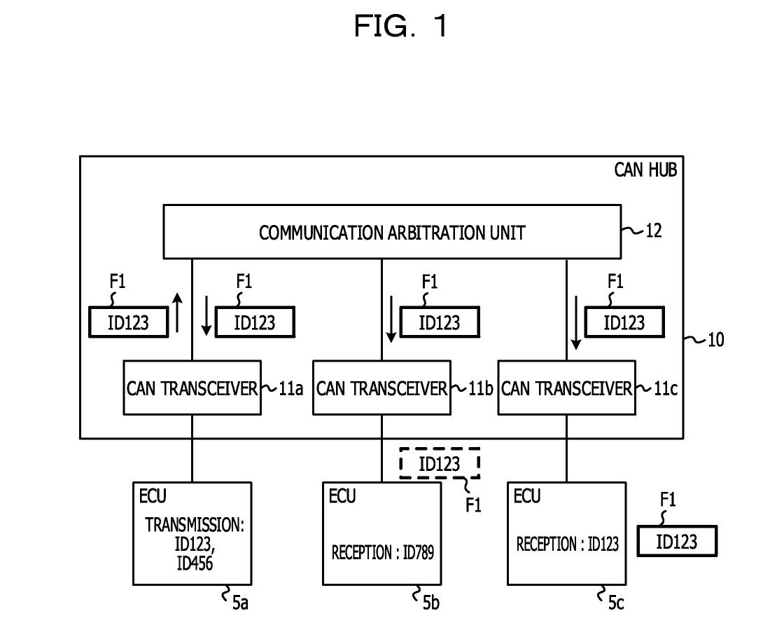

FIG. 2 illustrates an example of a case where transmission/reception processing is performed using an ID not set as an ID for use in transmission/reception processing;

FIG. 3 illustrates an example of a communication control method according to an embodiment;

FIG. 4 illustrates an example of a communication control method according to a first embodiment;

FIG. 5 illustrates an example of a hardware configuration of a communication control device;

FIG. 6 illustrates examples of formats of frames that are transmitted/received;

FIG. 7 is a diagram for describing an example of operations of a control unit and selecting unit;

FIG. 8 is a diagram for describing an example comparison processing;

FIG. 9 illustrates an example of an unused ID list;

FIG. 10 is a diagram for describing an example of operations of the control unit and selecting unit;

FIG. 11 is a flowchart for describing an example of processing performed at the control unit;

FIG. 12 is a flowchart for describing an example of processing performed at the control unit;

FIG. 13 illustrates an example of the configuration of a communication control device according to a second embodiment;

FIG. 14 illustrates an example of a used ID list;

FIG. 15 is a flowchart for describing an example of processing performed at the control unit; and

FIG. 16 is an example of a frame list.

### DESCRIPTION OF EMBODIMENTS

It is difficult for the related art to protect a system from an attack using unauthorized frames. For example, even if wiring used to input an unauthorized frame is cut, the bit string read in to determine whether or not the input frame is unauthorized may be input to the Controller Area Network (CAN) hub in fragments, and may be output from the ports of the CAN hub. If frame fragments are output to the ports, one or more errors are detected at the ECUs coupled to the ports. This may lead to system congestion due to error frames being output from the ECUs. Also, in a case of where a pseudo transmission-failed state is generated at a device regarding which data transmission is to be suppressed, error frames to notify the transmission-failed state may cause congestion. Even in a case of transmitting dummy frames to a gateway device, the dummy frames are received by the gateway. Accordingly, these methods are inappropriate for prevention of reception of unauthorized frames.

Embodiments are described hereinafter which aim to improve the resistance of systems as to attacks using unauthorized frames.

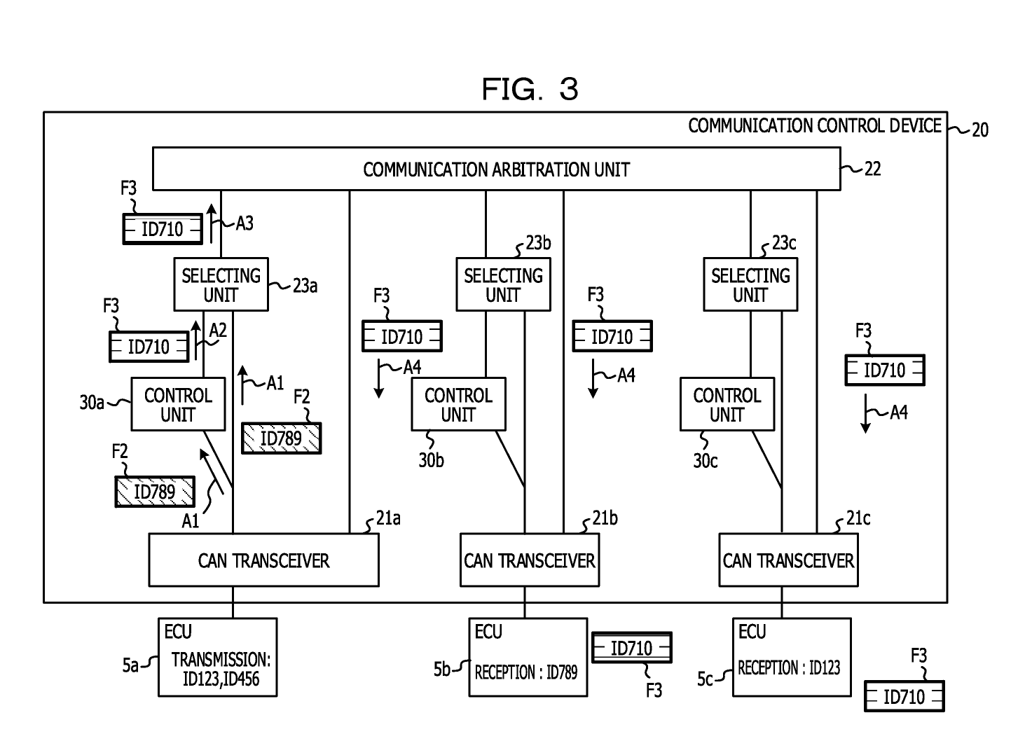

FIG. 3 illustrates an example of a communication control method according to an embodiment. In a communication control device 20 illustrated in FIG. 3, outputs from controller area network (CAN) transceivers 21 (21a, 21b, and 21c) are branched to selecting units 23 (23a, 23b, and 23c) and control units 30 (30a, 30b, and 30c). The control units 30 can output data to the selecting units 23. Accordingly, upon a selecting unit 23 having acquired frames from both a CAN transceiver 21 and a control unit 30 within a predetermined amount of time, the selecting unit 23 selects from the acquired frames a frame to be output to a communication arbitration unit 22. The predetermined amount of time is a value set within a range of time regarding which estimation can be made that both the input from the control unit 30 and the input from the CAN transceiver 21 originate from the same frame. In the following description an arrangement will be described in which the selecting unit 23 uses the value of the ID of the input frame to select that which is to be output to the communication arbitration unit 22.

The communication control device 20 stores beforehand, for each port, identification information which an electrical control unit (ECU) 5 coupled to that port uses for transmission processing. Further, the communication control device 20 stores information for identifying identification information not received by any ECU 5 coupled to any port. Information to identify identification information not received by any ECU 5 coupled to any port may be information in an optional format, including a list of identification information not received at any port, for example.

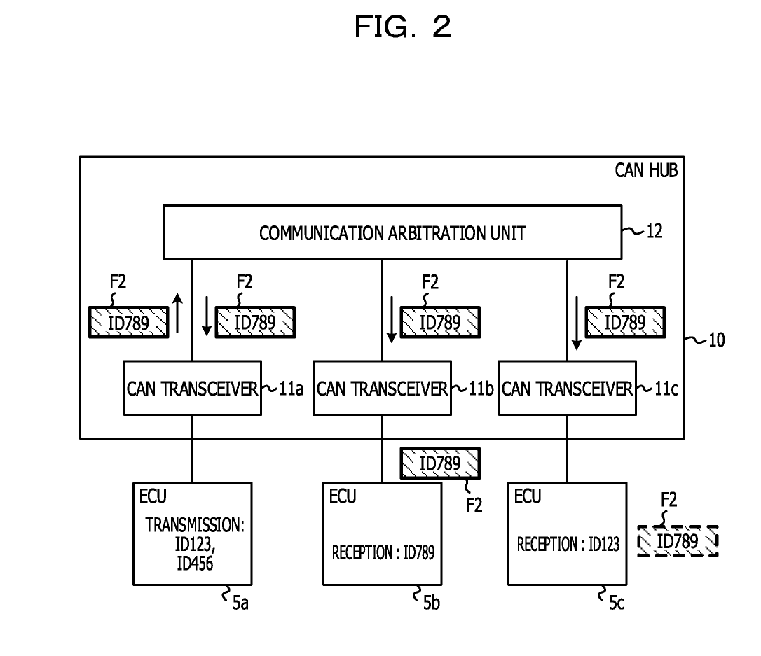

In the example in FIG. 3, the ECU 5a uses an ID “123” and an ID “456” for transmission processing, when operating normally. However, assumption will be made there that a the ECU 5a has been externally attacked, in the same way as in the case in FIG. 2, and has transmitted a frame F2 in which is set an ID “789” which is not set as an ID to be used for transmission processing.

The data output from the CAN transceiver 21a is branched to the selecting unit 23a and the control unit 30a, as indicated by arrow A1. Accordingly, the frame F2 output from the CAN transceiver 21a is input to the selecting unit 23a and the control unit 30a.

The control unit 30a determines whether or not information identifying the frame F2 matches any one of the identifying information correlated with the reception port of the frame F2. In a case where there are multiple pieces of identifying information correlated with a reception port, the control unit 30 determines whether or not any one identification information correlated with the reception port matches identification information of the received frame. Assumption will be made that while the ID of the frame F2 is “789”, no ID “789” is registered to the reception port for the frame F2. In this case, the control unit 30a selects, of identification information that is not the object of reception of any ECU 5, identification information that is output to the communication arbitration unit 22 with higher priority that the frame F2 is selected by the selecting unit 23a. The control unit 30a outputs a frame F3 that takes the selected identification information as the ID to the selecting unit 23a instead of the frame F2 (arrow A2). The ID of the frame F3 is “710” here.

The frame F2 has been input to the selecting unit 23a from the CAN transceiver 21a, and further, the frame F3 has been input thereto from the control unit 30a. The frame F2 and the frame F3 have been received within a predetermined amount of time, so the selecting unit 23a uses the IDs of the frame F2 and frame F3 to select a frame to output to the communication arbitration unit 22. The ID of the frame F3 has been selected to have higher priority for an object of output to the communication arbitration unit 22 as compared to the frame F2. Accordingly, the selecting unit 23a selects the frame F3 as the object of output to the communication arbitration unit 22, and outputs the frame F3 to the communication arbitration unit 22 (arrow A3).

The communication arbitration unit 22 transfers the input frame F3 toward all ports, as indicated by arrow A4. Accordingly, the frame F3 is transmitted to the ECU 5a, ECU 5b, and ECU 5c. The ID of the frame F3 input from the communication control device 20 is “710”, so the ECU 5b determines that the frame F3 is not an object of reception, and discards the frame F3. In the same way, the ECU 5c also determines that the frame F3 is not an object of reception, and discards the frame F3.

Thus, transfer of unauthorized frames to the ECUs 5 is avoided by the method of this embodiment. Further, there is no occurrence of congestion of error frames due to frame fragments being transmitted and received over the network. Thus, the system is protected from attacks using unauthorized frames, by using the method of this embodiment. In other words, resistance to attacks is strengthened in the system using the communication control device 20.

### First Embodiment

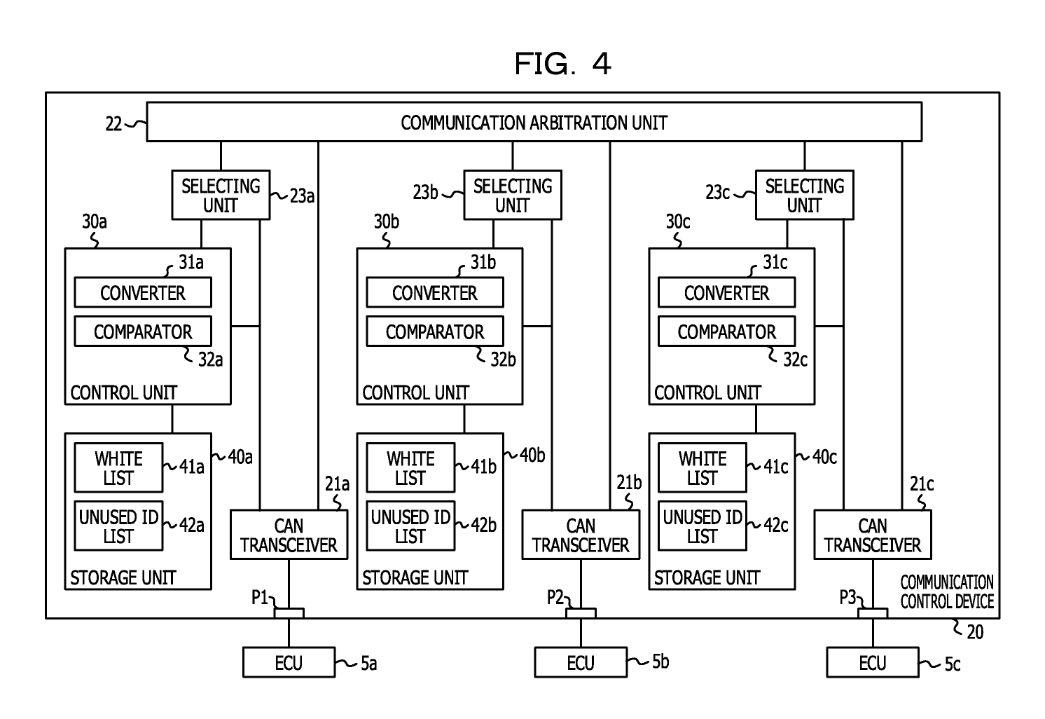

FIG. 4 illustrates an example of a communication control device according to a first embodiment. The communication control device 20 includes ports (P1, P2, and P3), CAN transceivers 21 (21a, 21b, and 21c), the communication arbitration unit 22, selecting units 23 (23a, 23b, and 23c), control units 30 (30a, 30b, and 30c), and storage units 40 (40a, 40b, and 40c). The control units 30 each have a converter 31 and comparator 32. The storage units 40 store a white list 41 and unused ID list 42.

The white list 41 correlates identification information to be used by the ECUs 5 coupled to the ports of the communication control device 20 for transmission of frames, with the ports. In a case where a white list 41 is generated for each port as illustrated in FIG. 4, the white list 41 stores identification information which the ECU 5 coupled to the port correlated with that white list 41 uses for frame transmission. For example, the white list 41a is correlated with port P1, so the ECU 5a coupled to the port P1 stores the identification information used for transmission processing. In the same way, the white list 41b is used for processing of frames input from port P2, so the ECU 5b coupled to the port P2 stores the identification information used for transmission processing. Further, the white list 41c is correlated with port P3, so the ECU 5c coupled to the port P3 stores the identification information used for transmission processing. The unused ID lists 42a through 42c store identification information which is not the object of reception regarding any of the ECUs 5 coupled to the communication control device 20.

The CAN transceivers 21 perform processing such as generating bus transmission voltage for transmission/reception of frames with the ECUs 5, adjustment of bus transmission voltage, and so forth. Output from the CAN transceivers 21 to the communication arbitration unit 22 is branched and input to selecting units 23 and control units 30.

Inside each control unit 30, a comparator 32 compares the identification information of a frame input from the CAN transceiver 21 with the identification information stored in the white list 41. In a case where the identification information of the input frame matches any one of the identification information stored in the white list 41 correlated with the port at which the frame has been received, the comparator 32 outputs the input frame to the selecting unit 23. That is to say, the comparator 32 handles a received frame having identification information registered in the white list 41 correlated with the reception port, as a frame transmitted from a normal ECU 5. On the other hand, in a case where the identification information of the input frame does not matches any one of the identification information correlated with the port at which the frame has been received, the comparator 32 notifies a converter 31 that an unauthorized frame has been input.

Upon detection of an unauthorized frame having been notified thereto, the converter 31 changes the identification information of the unauthorized frame into identification information that is not received at any ECU 5 and that is and ID output to the communication arbitration unit 22 with higher priority than the original ID. The converter 31 performs processing to output the frame of which the identification information has been changed to the selecting unit 23.

The selecting unit 23 outputs one frame selected from the frames input from the CAN transceiver 21 and control unit 30 to the communication arbitration unit 22. In the following description, the selecting unit 23 outputs to the communication arbitration unit 22 frames that have a smaller value representing the ID with higher priority. The communication arbitration unit 22 outputs the input frame toward all ports. In a case where multiple frames are input to the communication arbitration unit 22 simultaneously, the communication arbitration unit 22 selects one of the simultaneously input frames as a frame to be transferred.

While the example in FIG. 4 illustrates an example of a case where there are three ports coupled to the ECUs 5, the number of ports which the communication control device 20 uses for communication with the ECUs 5 is optional. Also, while FIG. 4 illustrates an example of a case where one control unit 30 and one storage unit 40 is provided for each port, the processing performed at the control units 30a through 30c may be performed at a single control unit 30, and the information sorted at the storage units 40a through 40c may be stored in a single storage unit 40.

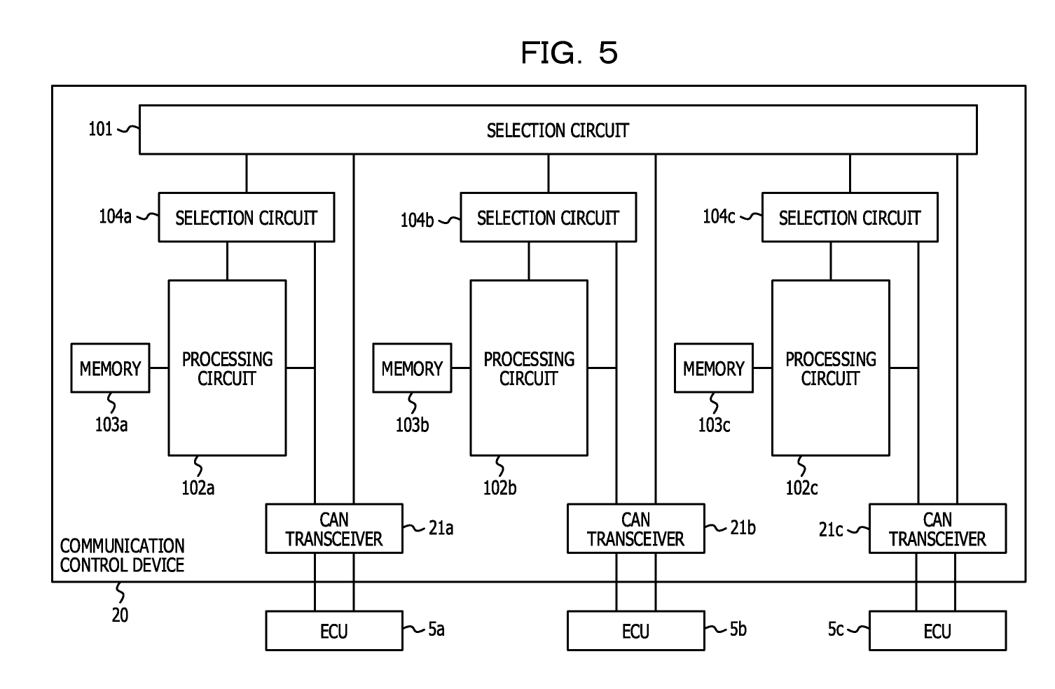

FIG. 5 is an example of the hardware configuration of the communication control device 20. Although FIG. 5 also illustrates a case where the number of ports is three, the number of ports of the communication control device 20 may be optionally decided according to the implementation. The communication control device 20 includes a selection circuit 101, processing circuits 102 (102a, 102b, and 102c), memory 103 (103a, 103b, and 103c), selection circuits 104 (104a, 104b, and 104c), CAN transceivers 21 (21a, 21b, and 21c), and ports (P1, P2, and P3). The selection circuits 101 and 104 are all optional ports which can select frames to be transmitted from the ports of the communication control device 20 out of multiple input frames. The selection circuit 101 operates as the communication arbitration unit 22. The selection circuits 104 operate as the selecting units 23. The processing circuits 102 each use information stored in memory 103 coupled to that processing circuit 102 to operate as the control units 30, as suitable. The memory 103 operates as the storage units 40. The communication control device 20 may be realized as a junction box, hub, repeater hub, or the like, for example.

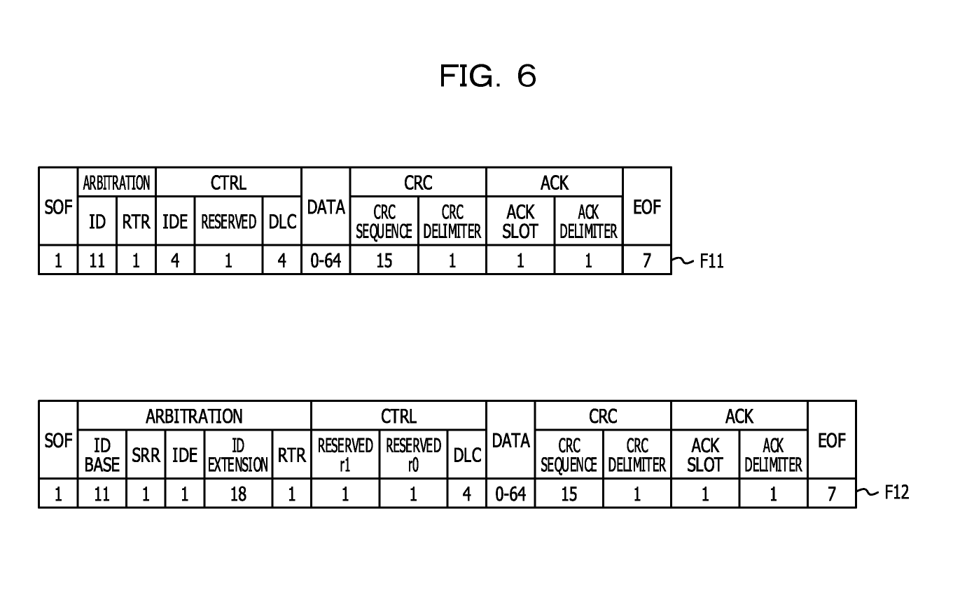

FIG. 6 illustrates examples of formats of frames that are transmitted and received. F11 in FIG. 6 is a frame format example for a general CAN specification, while F12 is a frame format example used in an extended CAN specification.

The general specification frame includes a Start of Frame (SOF), arbitration field, control field, data field, Cyclic Redundancy Check (CRC) field, acknowledge (ACK) field, and End of Frame (EOF). The arbitration field includes an ID and Remote Transmission Request (RTR). The ID is the identification information of the frame. The control field includes Identifier Extension (IDE), a reserved bit, and Data Length Code (DLC). The CRC field includes a CRC sequence and CRC delimiter. The ACK field includes an ACK slot and ACK delimiter. The bottom row of the F11 lists the bit lent of the information components included in each field. For example, the ID is 11 bits long, while the data field is variable in length, between 0 to 64 bits.

The frame used in the extended specification (F12) also includes an SOF, arbitration field, control field, data field, CRC field, ACK field, and EOF. The arbitration field in the extended specification includes an ID base and Substitute Remote Request Bit (SRR), IDE, ID extension, and RTR. The identification information (ID) in the extended specification is represented by a bit string obtained by appending a bit string stored as an extension ID following the bit string stored as an ID base. The control field includes reserved bits (r1 and r0), and DLC. From the data field up to the EOF is the same as in the general specification format. The bottom row of the F12 lists the bit length of the information components included in each field in the extended specification format as well. Accordingly, a bit string of 29 bits, obtained by adding the 11 bits of the ID base to the 18 bits of the ID extension, is used in the extended format as identification information.

An example of processing performed in the first embodiment will be described below, as an example where an unauthorized format using the format illustrated in F11 in FIG. 6 has been transmitted from the ECU 5a to the communication control device 20. Note that the same processing is performed in the case where the frame used for communication is of the extended specification as well. To facilitate understanding of the following description, a frame transmitted from the ECU 5a will be written as “first frame”.

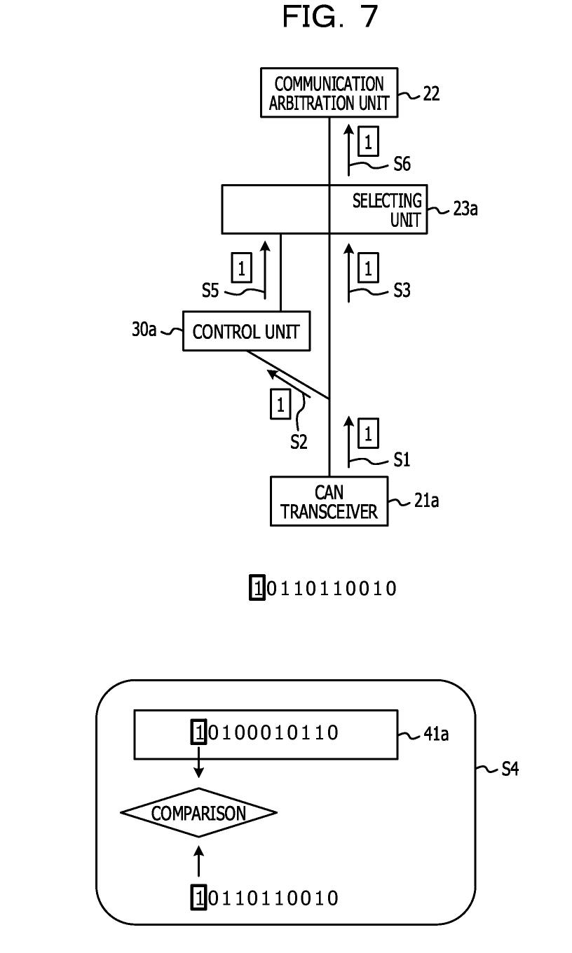

Upon the ECU 5a transmitting the first frame, the first frame is received by the communication control device 20 via the port P1. The CAN transceiver 21a outputs the first frame input from the port P1 toward the communication arbitration unit 22. The input lines from the CAN transceivers 21 to the communication arbitration unit 22 are branched, so the first frame is input to the selecting unit 23a and the comparator 32a. The first frame is input into the selecting unit 23a and comparator 32a in order from the first bit here, as illustrated in FIG. 7.

FIG. 7 is a diagram for describing the operations of the control units 30 and selecting units 23. In the example in FIG. 7, a case will be assumed where identification information 10100010110 is recorded in the white list 41a, but the ID of the frame input to the comparator 32 is 10110110010. Although a case where the number of identification information registered in the white list 41a is one is illustrated in the example in FIG. 7 to facilitate understanding, the number of identification information stored in each of the white lists 41 is optional. FIG. 7 illustrates the comparator 32a and converter 31a combined as the control unit 30a, for the sake of simplicity of the drawing.

In step S1, the CAN transceiver 21a outputs the first bit of the ID in the first frame (10110110010). The value of the first bit of the ID in the first frame is 1. The output from the CAN transceiver 21a branches to the comparator 32a (in the control unit 30a) and the selecting unit 23a. Accordingly, 1 is output to the comparator 32a as the value of the first bit in the ID of the first frame (Step S2). Further, the value of the first bit in the ID of the first frame is also output to the selecting unit 23a (step S3).

The comparing processing at the comparator 32a will be described with reference to step S4. Upon having acquired the first bit in the ID of the first frame, the comparator 32a determines whether any ID recorded in the white list 41a may match the ID of the first frame. That is to say, the first bit of the identification information recorded in the white list 41a and the input value are compared. Of the two bit strings illustrated in step S4, the lower bit string is the ID within the first frame. While the entire ID within the first frame is illustrated in step S4 to facilitate understanding that the values of the first bits of the IDs are being compared, at this point the comparator 32a has only acquired the first bit of the ID in the first frame. Since the value of the first bit in the ID of the first frame is 1, and the white list 41a contains identification information that starts from 1, the comparator 32a determines that there is a possibility that the first frame is not an unauthorized frame. Accordingly, the comparator 32a outputs the first bit of the ID of the first frame to the selecting unit 23a (step S5).

In step S3 and step S5, 1 is input from each of the CAN transceiver 21a and comparator 32a to the selecting unit 23a, as the value of the first bit of the ID. In a case where the value of the bit input from the CAN transceiver 21a and the value of the bit input from the comparator 32a are equal, the selecting unit 23a outputs the value input form the CAN transceiver 21a to the communication arbitration unit 22. FIG. 7 illustrates the way which the bit output from the CAN transceiver 21a is output to the communication arbitration unit 22, by the line from the CAN transceiver 21a through the selecting unit 23a and reaching the communication arbitration unit 22. The value of the bit input to the communication arbitration unit 22 is output to the ports by the communication arbitration unit 22. Note that the communication arbitration unit 22 outputs the bits in the frames transmitted to the ports by wiring (FIG. 4) coupled to the CAN transceivers 21 without going through the selecting units 23a through 23c.

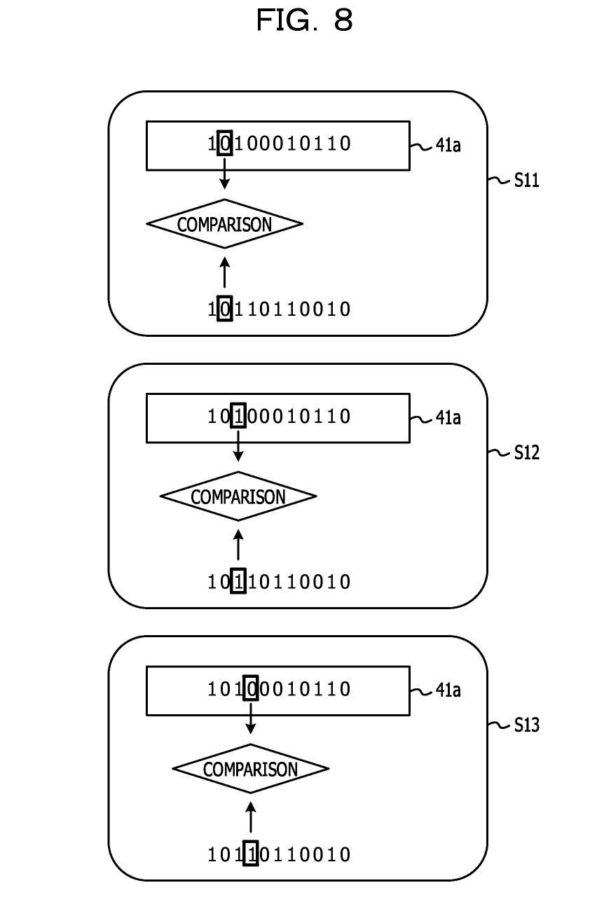

FIG. 8 is a diagram for describing an example of the comparing processing. While all of the bits of the ID within the first frame are illustrated as a bit string of bits, below the steps (S11 through S13) in FIG. 8 as well, for the sake of description, only the bits surrounded by the heavy lines are the values input to the comparator 32a at each step.

Step S11 is an example of comparing processing performed when the second bit of the ID of the first frame is input to the comparator 32a. The second bit of the ID of the first frame is also output to the comparator 32a and selecting unit 23a in the same way as the procedures described with reference to FIG. 7. The comparator 32a determines whether or not the second bit of any of the identification information in the white list 41a, regarding which the first bit matched the ID of the first frame, matches the input bit value. In other words, the comparator 32a determines whether or not the bit string of the first two bits of the first frame matches the first two bits of any identification information in the white list 41a. In the example illustrated in step S11, the second bit of the identification information (10100010110) in the white list 41a regarding which the first bit matched that of the ID of the first frame is 0, and the second bit of the ID of the first frame input to the comparator 32a also is 0. Based on the comparison results between the first and second bits of the ID in the first frame and the white list 41a, the comparator 32a determines that there is a possibility that the first frame is not an unauthorized frame. Accordingly, the comparator 32a outputs the second bit of the ID of the first frame to the selecting unit 23a.

The processing which the selecting unit 23a performs at the time of data being output from the comparator 32a to the selecting unit 23a due to the processing of step S11 is the same as the processing described with reference to FIG. 7. Accordingly, the value of the second bit of the ID of the first frame is input to the communication arbitration unit 22. The communication arbitration unit 22 outputs the value of the input bit to the ports.

Step S12 is an example of comparing processing performed when the third bit of the ID of the first frame is input to the comparator 32a. The comparator 32a performs the same processing in step S12 as that in step S11. As a result, the first through third bits of the ID match the identification information in the white list 41a, so the comparator 32a determines that there is a possibility that the first frame is not an unauthorized frame. The third bit of the first frame is output to the selecting unit 23a from both the comparator 32a and the CAN transceiver 21a. Accordingly, the third bit of the first frame is also output to the communication arbitration unit 22. The processing which the communication arbitration unit 22 performs is the same as the processing performed when the second bit was input in step S11.

Step S13 is an example of comparison processing performed when the fourth bit of the ID of the first frame is input to the comparator 32a. There is no identification information included in the white list 41a regarding which the values of the first through fourth bits match the first through fourth bits of the ID of the first frame, so the comparator 32a determines that the first frame is an unauthorized frame. The comparator 32a notifies the converter 31a that an unauthorized frame has been detected. The comparator 32a does not output the value of the fourth bit of the ID of the first frame to the selecting unit 23a. Now, at this point, the comparator 32a has already output the first through third bits of the first frame to the selecting unit 23a, so the values of the first third bits of the ID of the first frame have been output to the communication arbitration unit 22 via the selecting unit 23a. Accordingly, the comparator 32a notifies the converter 31a that the values of the first through third bits of the ID of the first frame are values that have already been output to the selecting unit 23a. Further, the comparator 32a also outputs the value of the bit used to determine that the first frame is an unauthorized frame, to the converter 31a.

The converter 31a selects identification information that is given higher propriety at the selecting unit 23a than the bit string which the comparator 32a has taken as the object of comparison processing, and that includes at the start of the bit string of the ID the bit string already output, to the selecting unit 23a, from the unused ID list 42a. The converter 31a uses the selected identification information as the ID of a second frame to be output as a substitute for the first frame. The identification information included in the unused ID list 42a is identification information that will not be received at any ECU 5, so even if the second frame is output from the ports, no ECU 5 will receive it.

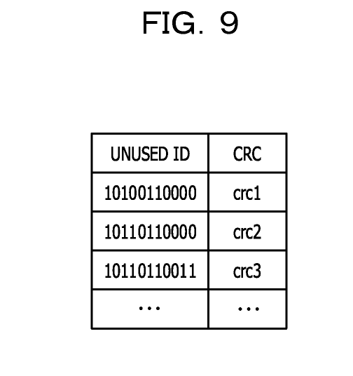

FIG. 9 illustrates an example of an unused ID list 42. The unused ID list 42 includes identification information that will not be received by any ECU 5 in the system, and values of CRCs correlated with each identification information. The CRCs are CRCs calculated regarding cases of values where the data field values in frames including the identification information in the unused ID list 42 are predetermined values. A data field value used for calculating the CRC is used as the data field value for the second frame. An example will be described below regarding a case where 0 is recorded for all bits of the data field.

Next, the details of the converter 31a deciding the ID for the second frame will be described. In the example described by way of FIGS. 7 and 8, The comparator 32a detects that the frame is an unauthorized frame after having output the first three bits of the ID of the input frame to the communication arbitration unit 22. Accordingly, as far as the bit string 101 has been output to the communication arbitration unit 22 as the ID. Accordingly, the converter 31a selects identification information which has 101 as the first three bits and which has a smaller value than the value of the ID of the first frame, as the ID of the second frame, from the identification information sorted in the unused ID list 42a. In the following example, assumption will be made that the converter 31a has selected identification information 10100110000 from the unused ID list 42a. The converter 31a acquires the value of the CRC correlated with the selected identification information from the unused ID list 42a as well. In this example, the value of the CRC correlated with the identification information which the converter 31a has selected is crc1.

The converter 31a outputs to the selecting unit 23a a bit string obtained by deleting, from the front of the selected identification information, the number of bits already output to the selecting unit 23a, as the continuation of the ID. In the example illustrated in FIG. 8, the first three bits (101) of the ID of the first frame have already been output to the selecting unit 23a when the frame was detected as being unauthorized. Accordingly, the converter 31a outputs the fourth bit and thereafter of the identification information selected from the unused ID list 42a (00110000) to the selecting unit 23a. The “101” has already been input to the selecting unit 23a as described with reference to step S13 in FIG. 8, so the ID input to the selecting unit 23a is thus “10100110000”.

Now, in a case where an ID given higher preference than the first ID from the bit string notified from the comparator 32 is difficult to be selected, the converter 31 outputs to the selecting unit 23 a value regarding which there is a possibility that the priority at the selecting unit 23 may rise, and then selects an ID using the value of the bits into the comparator 32. The converter 31 continues to acquire values of bits input to the comparator 32 and output to the selecting unit 23 values regarding which there is a possibility that the priority at the selecting unit 23 may rise, until identification information which will be give priority at the selecting unit 23 can be selected. For example, in a case where the first frame is identified as being an unauthorized frame at the fifth bit of the ID (10110110010) of the first frame, the four bits of “1011” have already been output to the selecting unit 23. Based on the fact that the value of the fifth bit used in the comparing processing is “0” and that the selecting unit 23 gives higher priority the smaller the value of the ID is, the converter 31 determines that identifying information given priority at the selecting unit 23 is difficult to be identified from the bit string identified from the comparator 32. The converter 31 then outputs “0” as the value of the fifth bit of the ID to the selecting unit 23, and next acquires the value input to the comparator 32 next. The value of the sixth bit of the ID is “1”, so identification information regarding which the value of the sixth bit is given priority at the selecting unit 23 over the ID of the first frame. Accordingly, the converter 31 decides identification information in the unused ID list 42 starting with “101100” to be the ID of the second frame.

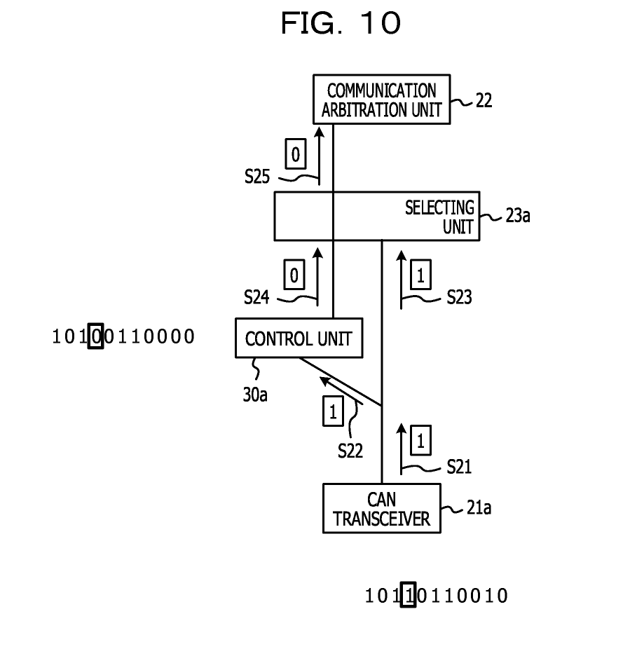

FIG. 10 is a diagram for describing an example of operation of the control units 30 and selecting units 23. FIG. 10 illustrates an example of processing performed at the time of processing of the fourth bit of the ID. A specific example of selection processing performed at the selecting unit 23a will be described with reference to FIG. 10.

In step S21, the value of the fourth bit of the ID is output from the CAN transceiver 21a. The output from the CAN transceiver 21a is input to both the comparator 32a and the selecting unit 23a, as illustrated in step S22 and S23. The comparison processing as to the bit input to the comparator 32a in step S22 and way by which the ID of the second frame is obtained, are the same as described with reference to step S13 in FIG. 8 and to FIG. 9. Accordingly, the converter 31a outputs 0, which is the value of the fourth bit of the identification information selected as the ID of the second frame (10100110000) to the selecting unit 23a, as illustrated in step S24.

In a case where the value of the bit input from the CAN transceiver 21a and the value of the bit input from the control unit 30a differ, the selecting unit 23a selects the frame input from the source with the smaller value as the object of output to the communication arbitration unit 22. While the value of the bit input from the CAN transceiver 21a is 1 here, the value input from the converter 31a within the control unit 30a is 0. Accordingly, the selecting unit 23a changes the settings to output information input from the control unit 30a to the communication arbitration unit 22 thereafter. FIG. 10 illustrates the way in which the bit output from the control unit 30a is output to the communication arbitration unit 22, by the line from the control unit 30a through the selecting unit 23a to the communication arbitration unit 22.

Upon the processing for changing the ID ending, the converter 31a sets all bits in the data field to 0, and outputs the value of the CRC acquired from the unused ID list 42a to the comparator 32a. Once this processing ends, the comparator 32a outputs the bit string following the CRC sequence in the first frame to the selecting unit 23a.

Note that an arrangement may be made where, upon the processing for changing the ID ending, DLC is set to “0” and no data field is included in the frame, instead of setting the values of all bits of the data field to 0. Alternatively, the converter 31a may use a separate predetermined value as the data of the frame after changing the ID.

According to these processes, the converter 31a can be said to be converting the unauthorizedly-transmitted first frame into a second frame that will not be received at any ECU 5, by changing part of the ID of the first frame, the data field, and the value of the CRC sequence. The second frame is output to the communication arbitration unit 22 with higher priority than the first frame, due to the processing performed by the selecting unit 23a described with reference to FIG. 10.

Processing regarding a case where an unauthorized frame was transmitted to the communication control device 20 has been described with reference to FIGS. 8 through 10, but if the received frame is not an unauthorized frame, the communication control device 20 outputs the received frame from the ports. The processing performed in this case is as described with reference to FIG. 7 and to steps S11 and S12 in FIG. 8.

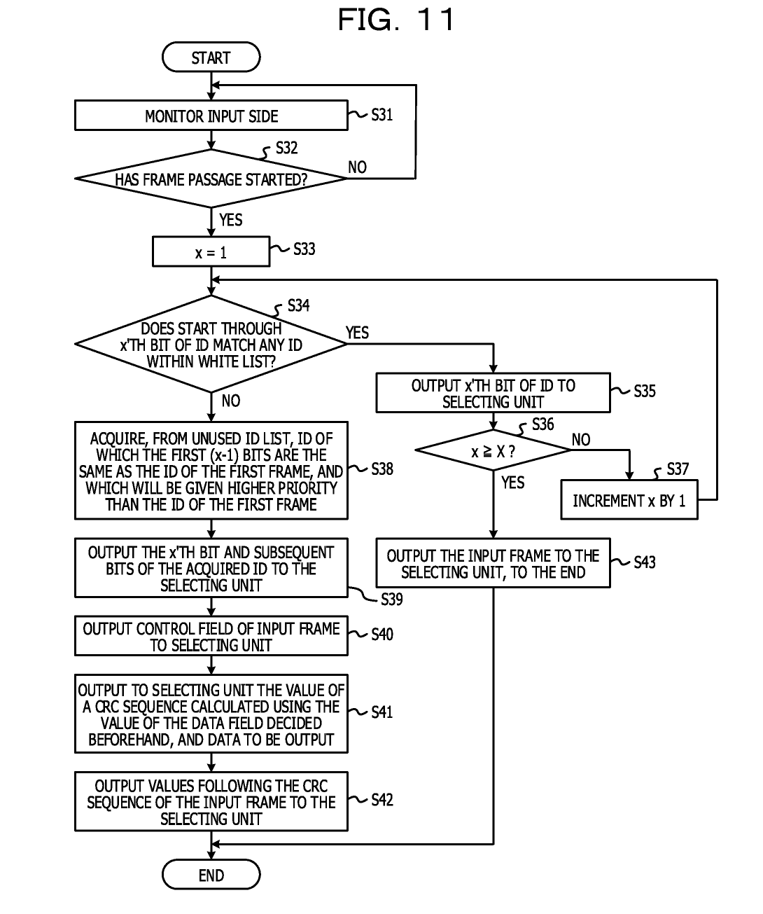

FIG. 11 is a flowchart for describing an example of processing performed at the control units 30. Note that in the example in FIG. 11, a constant X and a variable x are used. The variable x is used to count the number of bits of the ID of the input frame that have been compared with the identification information in the unused ID list 42. The constant X is the total number of bits used to describe the ID in the frame used for communication. The processing illustrated in FIG. 11 is only an example, and the processing may be changed depending on the implementation. For example, the processing of step S33 may be performed first.

The comparator 32 monitors data input from the wiring between itself and the CAN transceiver 21 which is the input side for frames, and determines whether or not passage of a frame has started (steps S31 and S32). The comparator 32 determines that passage of a frame has started using the SOF of the received frame. For example, the comparator 32 may determine that passage of a frame has started upon input of a SOF, or may passage of a frame has started upon outing of the SOF to the selecting unit 23. Upon passage of a frame having started, the comparator 32 sets the variable x to 1 (Yes in step S32, step S33). The comparator 32 determines whether the bit string from the start of the ID to the x'th bit matches any identification information included in the white list 41 (step S34). The determination method performed at the comparator 32 is the same as that described with reference to FIGS. 7 and 8. In a case where the bit string from the start of the ID to the x'th bit matches any identification information included in the white list 41, the comparator 32 outputs the x'th bit of the ID to the selecting unit 23 (Yes in step S34, step S35). The comparator 32 determines whether the value of the variable x is equal to or larger than the constant X (Step S36). In a case where the value of the variable x is smaller than the constant X, the comparator 32 increments the variable x by 1, and returns to step S34 (No in step S36, step S37).

On the other hand, in a case where the bit string from the start of the ID to the x'th bit does not match any identification information included in the white list 41, the comparator 32 notifies the converter 31 that the input frame is an unauthorized frame (No in step S34). The comparator 32 also notifies the converter 31 of the bit string of (x−1) bits of the ID of the unauthorized frame (first frame), that have already been output to the selecting unit 23.

The converter 31 acquires identification information from the unused ID list 42 regarding which the first (x−1) bits of the ID are the same as the first (x−1) bits of the identification information of the first frame, that will be give higher priority than the ID of the first frame (step S38). The processing example performed in step S38 is that which has been described with reference to FIGS. 9 and 10. At this time, the converter 31 also acquires the value of a CRC correlated with the identification information acquired from the unused ID list 42. Next, the converter 31 outputs the portion of the acquired ID from the x'th bit and subsequent bits, to the selecting unit 23 (step S39). Accordingly, the ID which the converter 31 has selected is notified to the selecting unit 23 as the ID. Upon the input processing of the ID ending at the converter 31, the comparator 32 outputs the control field of the input frame to the selecting unit 23 (step S40). Next, the converter 31 outputs a bit string of which the bit length of the data field is the same but with the values of the bits all set to 0, and the value of the CRC correlated with the identification information output to the selecting unit 23, to the selecting unit 23 (step S41). Accordingly, the selecting unit 23 receives output of data of which all bits are 0 and a CRC regarding a case where all bits of the data field are 0, instead of the data within the first frame. Thereafter, the comparator 32 outputs the values following the CRC sequence of the input frame to the selecting unit 23 (step S42).

Accordingly, the selecting unit 23 acquires a second frame that is different from the first frame from the control unit 30, instead of the unauthorized first frame, by the processing of steps S38 through S42. The ID of the second frame is a value that will not be received at any of the ECUs 5, and further is a value that will be given priority at the selection processing at the selecting unit 23 as compared to the first ID. It can be said that the control unit 30 generates the second frame from the first frame in the processing of steps S38 through S42.

On the other hand, in a case where the value of the variable x is equal to or larger than the constant X in step S36, the ID of the input frame matches the identification information in the white list 41, so the comparator 32 determines that the input frame is not an unauthorized frame (Yes in step S36). The comparator 32 further outputs to the selecting unit 23 input frames to the end (step S43). In this case, the received frame is output to the selecting unit 23, so the selecting unit 23 outputs the first frame acquired from the CAN transceiver 21 to the communication arbitration unit 22, and the communication arbitration unit 22 outputs the first frame to the ports.

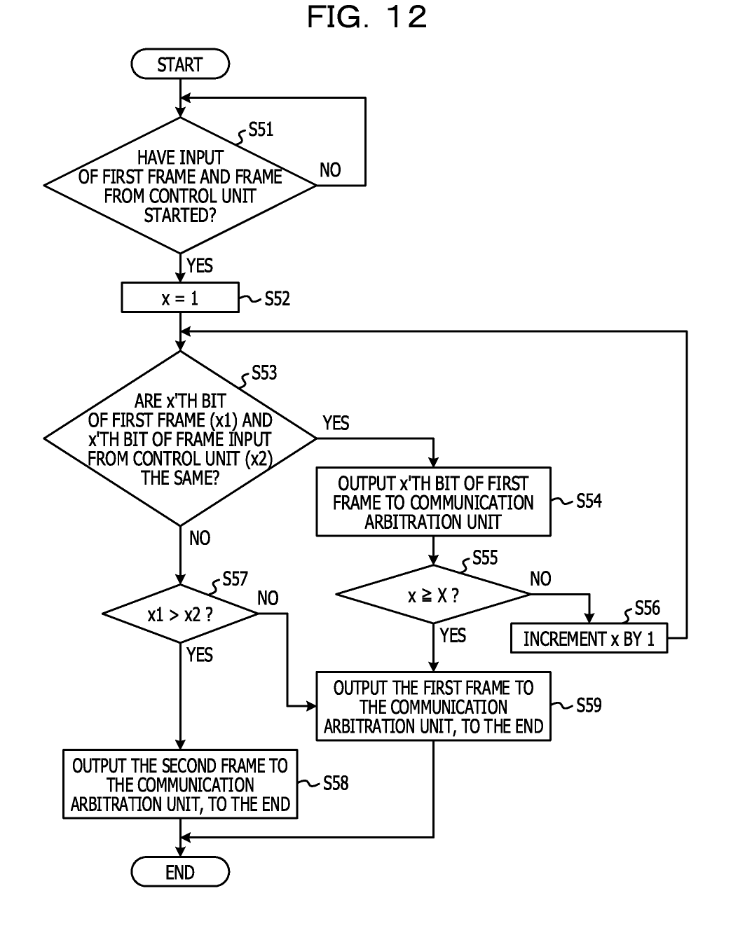

FIG. 12 is a flowchart for describing an example of processing performed at the selecting unit 23. In FIG. 12, a frame input from the CAN transceiver 21 to the selecting unit 23 is called the first frame. In a case where the first frame is not an unauthorized frame, the frame input from the control unit 30 is the same frame as the first frame, but in a case where the first frame is an unauthorized frame, the frame input from the control unit 30 is replaced by the second frame. The variable x is used to count the number of bits of the ID of the input frame that have been compared with the identification information in the unused ID list 42, in FIG. 12 as well. The constant X is the total number of bits used to describe the ID in the frame used for communication. Changes may be made to FIG. 12, such as the processing of step S52 being performed first, or the like.

The selecting unit 23 stands by until both input of the first frame from the CAN transceiver 21 and input from a frame from the control unit 30 start (No in step S51). Upon input of the first frame from the CAN transceiver 21 and input from a frame from the control unit 30 starting, the selecting unit 23 sets the variable x to 1 (step S52). The selecting unit 23 determines whether the value of the x'th bit of the first frame is the same as the x'th bit of the frame input from the control unit 30 (step S53). In a case where the value of the x'th bit input from the CAN transceiver 21 is the same as the x'th bit of the frame input from the control unit 30, the selecting unit 23 outputs the input from the CAN transceiver 21 to the communication arbitration unit 22 (Yes in step S53). Accordingly, the selecting unit 23 outputs the x'th bit of the first frame to the communication arbitration unit 22 (step S54). The selecting unit 23 determines whether the value or the variable x is equal to or larger than the constant X (step S55). In a case where the value of the variable x is smaller than the constant X, the comparator 32 increments the variable x by 1, and returns to step S53 (No in step S55, step S56).

Next, description will be made regarding a case where the value of the x'th bit of the first frame input from the CAN transceiver 21 (x1) and the x'th bit of the frame input from the control unit 30 (x2) differ (No in step S53). In a case where a determination of No is made in step S53, the selecting unit 23 has acquired the first frame from the CAN transceiver 21, and has acquired the second frame that is different from the first frame from the control unit 30. Accordingly, x1 is the value of the x'th bit of the first frame, and x2 is the value of the x'th bit of the second frame. The selecting unit 23 compares x1 and x2, regarding which is larger (step S57).

In the example in FIG. 12, The CAN transceiver 21 decides the smaller of the input value from the control unit 30 and CAN transceiver 21 to be output to the communication arbitration unit 22. Accordingly, in a case where x1 is larger than x2, the selecting unit 23 outputs to the communication arbitration unit 22 the second frame acquired from the control unit 30 to the end (Yes in step S57, step S58). On the other hand, in a case where x1 is smaller than x2, the selecting unit 23 outputs to the communication arbitration unit 22 the first frame to the end (No in step S57, step S59). Note that the converter 31 selects a value smaller than the ID of the first frame from the unused ID list 42 as the ID for the second frame, as described with reference to FIG. 11 and so forth, so that the selecting unit 23 does not perform the processing of step S59.

In a case where the value of the variable x is equal to or larger than the contest X in step S55, the frame input from the CAN transceiver 21 and the frame input from the control unit 30 match (Yes in step S56). Accordingly, the selecting unit 23 outputs to the communication arbitration unit 22 the first frame acquired from the CAN transceiver 21 to the end (step S59). The communication arbitration unit 22 outputs the first frame to the ports.

As described above, an unauthorized first frame is discarded at the selecting unit 23 according to the first embodiment, so the ECUs 5 are able to avoid receiving unauthorized frames. Further, a second frame which will not be received at any of the ECUs 5 but does not include any error-causing components is transmitted from the communication arbitration unit 22 instead of the first frame. Accordingly, the first embodiment also avoids congestion of error messages due to frame fragments being transmitted to the ECUs 5, such as in a case where wiring is cut off upon having detected that an unauthorized frame has been input.

The first embodiment is particularly advantageous in a case of avoiding attacks using unauthorized IDs in a system which performs real-time processing of frames input from the ports in the communication control device 20. That is to say, the communication control device 20 does not buffer the frames received from the ECUs 5, in order to reduce delay as much as possible in processing where frames are handled in real time. Accordingly, the CAN transceiver 21 and control unit 30 process the input bits before the entire ID is received. The selecting unit 23 also outputs one of the input from the control unit 30 and CAN transceiver 21 to the communication arbitration unit 22. The information input to the communication arbitration unit 22 will be output to the ports if no arbitration is performed, so that the stage that the comparator 32 has detected that the first frame is an unauthorized frame, part of the ID of the frame may already have been output to the ports via the communication arbitration unit 22. Accordingly, the converter 31 selects, of identification information that will not be received at any of the ECUs 5, an ID including the bit string already output to the selecting unit 23 at the start thereof. The converter 31 also selects a value that will be given propriety at the selecting unit 23 over the ID of the first frame as the ID for the second frame, so that the second frame output to the selecting unit 23 from the control unit 30 will be selected as the object to be output to the communication arbitration unit 22. Thus, according to the first embodiment, the system can be protected from attacks using unauthorized frames, without interfering with processing where real-time handling of frames is important.

### Second Embodiment

Description will be made in the second embodiment regarding a case where a list of IDs which are the object of reception at the ECUs 5 (used ID list 43) is used instead of the unused ID list 42. Assumption will be made in the second embodiment that the values of the data field in the second frame are determined to be a certain value beforehand, in the same way as the first embodiment.

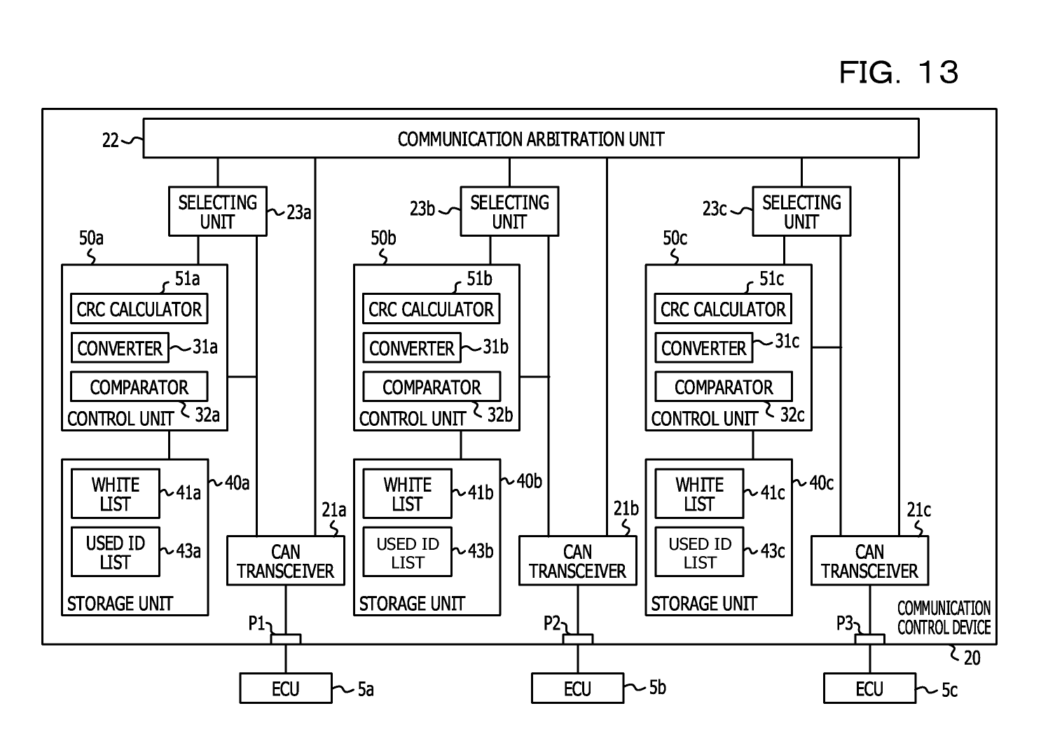

FIG. 13 illustrates an example of the configuration of a communication control device 60. The communication control device 60 includes ports P1, P2, and P3, CAN transceivers 21 (21a, 21b, and 21c), the communication arbitration unit 22, selecting units 23 (23a, 23b, 23c), control units 50 (50a, 50b, and 50c), and storage units 40 (40a, 40b, and 40c). The control units 50 each have a converter 31, comparator 32, and CRC calculator 51. The storage units 40 store a white list 41 and used ID list 43. The operations of the CAN transceivers 21, communication arbitration unit 22, selecting units 23, and comparators 32, are the same as in the first embodiment. Note that the control units 50 are realized by the processing circuits 102 (FIG. 5).

In a case where the ID of the first frame is not included in the white list 41, the comparator 32 notifies the converter 31 of detection of an unauthorized frame, and the bit string already output to the comparator 32 as an ID. The converter 31 uses the used ID list 43 to decide identification information that includes the bit string already output, that will not be received at any of the ECUs 5, and that will be give higher priority over the first frame.

The CRC calculator 51 calculates the value of the CRC to be set to the second frame, using the ID of the second frame to be output instead of the first frame which has been identified as being an unauthorized frame, data field values, and so forth. The CRC calculator 51 acquires the ID of the second frame from the converter 31. In the following example, the value of the data field in the second frame has been decided to a predetermined value beforehand, so the CRC calculator 51 calculates the CRC using the value of the ID acquired from the converter 31 and the value of the data field of the second frame, and CAN-stipulated data for CRC calculation.

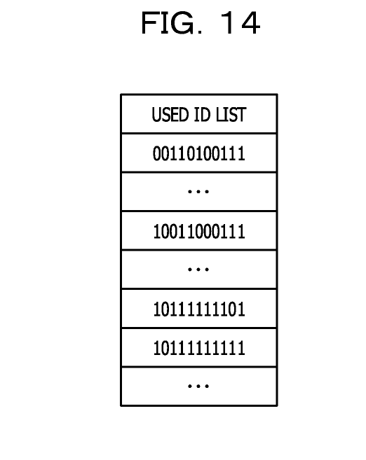

FIG. 14 illustrates an example of the used ID list 43. The used ID list 43 includes identification information that is to be the object of reception an any one of the ECUs 5 coupled to the communication control device 60. Note that the used ID list 43 may store just the identification information that is to be the object of reception, as illustrated in FIG. 14, or may store information where the identification information and the identification information of the ECU 5 that will receive frames from that identification information have been correlated.

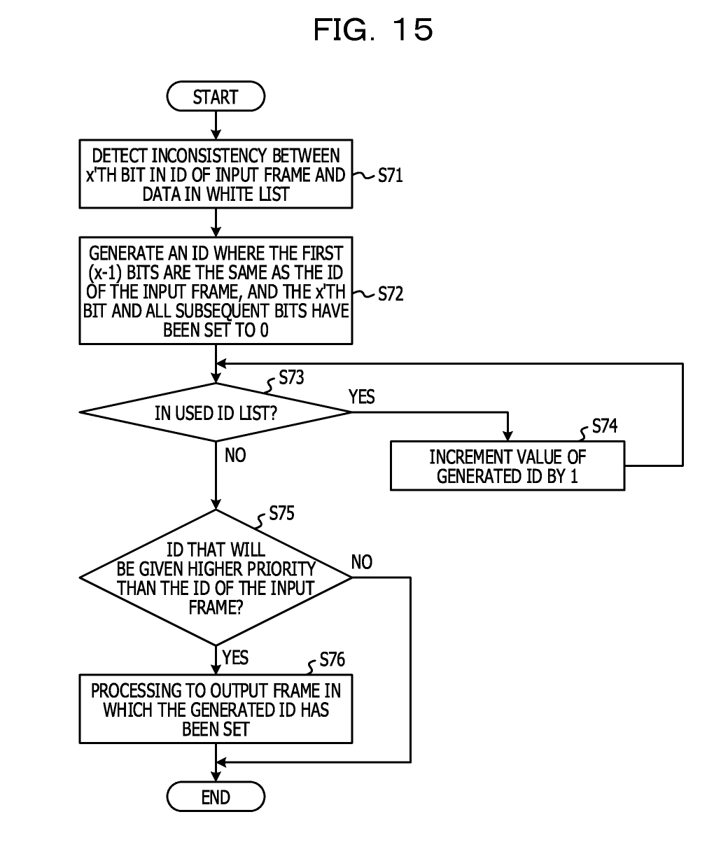

FIG. 15 is a flowchart for describing an example of processing performed at the control units 50. The way in which the ID for the second frame to be output to the selecting unit 23 instead of the unauthorized first frame is obtained will be described with reference to FIG. 15. Processing performed in a case where there is a possibility that the input frame is not an unauthorized frame is the same as that in the first embodiment.

Assumption will be made that in step S71, the comparator 32 has detected that the ID does not match any identification information in the white list 41, by the processing regarding the x'th bit of the ID in the input frame. The comparator 32 notifies the converter 31 of reception of an unauthorized frame, and also notifies of the first (x−1) bits of the ID of the unauthorized frame.

The converter 31 generates an ID where the first (x−1) bits are the same as the ID of the input frame, and the X'th bit and thereafter are all set to 0 (step S72). Further, the converter 31 determines whether or not the generated ID is included in the used ID list 43 (step S73). In a case where the generated ID is included in the used ID list 43, the converter 31 increments the value of the generated ID by 1, and returns to step S73 (Yes in step S73, step S74). The converter 31 repeats the processing of steps S73 and S74 until an ID not included in the used ID list 43 is detected.

In a case where the generated ID is not included in the used ID list 43, the converter 31 determines whether the generated ID is an ID which will be given higher priority at the selecting unit 23 as compared to the ID of the input frame (step S75). In a case where there generated ID is an ID which will be given higher priority at the selecting unit 23 as compared to the ID of the input frame, the converter 31 and comparator 32 perform processing to output the frame, in which has been set the obtained ID, to the selecting unit 23 (Yes in step S75, step S76). That is to say, in step S76 the converter 31 replaces the ID by outputting to the selecting unit 23 the x'th bit and subsequent bits of the ID regarding which determination is made that it is not included in the used ID list 43. The converter 31 also outputs the value decoded beforehand as the value of the data field, to the selecting unit 23. Thereafter, the CRC calculator 51 decides the value of the CRC sequence to be set in the second frame, using the ID of the second frame output to the selecting unit 23 and the value of the data field, and the CAN-stipulated data for CRC calculation. After input of the CRC sequence, the comparator 32 outputs the bits following the CRC sequence in the first frame to the selecting unit 23.

According to the second embodiment, transfer of unauthorized frames may be avoided in the same way as with the first embodiment, by sorting IDs used at any one of the ECUs 5 coupled to the communication control device 60 as a used ID list 43. In a case where the number of ECUs 5 coupled to the communication control device 60 is small, or the number of types of IDs received by the ECUs 5 coupled to the communication control device 60 is small, the amount of data of the used ID list 43 will be smaller than the amount of data of the unused ID list 42. Accordingly, the amount of information which the communication control device 60 stores can be reduced by the converter 31 deciding the ID to use for transfer processing using the used ID list 43, as compared to using the unused ID list 42. Accordingly, the second embodiment is advantageous over the first embodiment in that the available amount of memory which the communication control device 60 can use for processing can be increased.

### Others

The above embodiments are not restrictive, and various modifications may be made. The following is an example of a few.

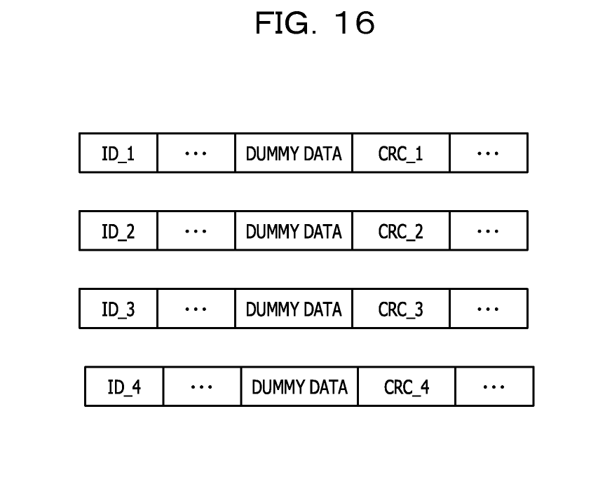

FIG. 16 is an example of a frame list. The communication control device 20 may have a frame list instead of the unused ID list 42. The frame list records a list of frames which can be used as substitutes for unauthorized frames. All of the frames in the frame list have IDs set to values which will not be received at any of the ECUs 5. Each frame includes beforehand a CRC calculated using the frame ID and dummy data. For example, the CRC calculated using ID_1 and dummy data is CRC_1. The dummy data is a value of an operation number of bits, and may be set to different values from one frame to another within a single frame list.

In a case of using a frame list, the method of the converter 31 selecting identification information to be used as the ID of the second frame is the same as with the first embodiment. The converter 31 extracts a frame including identification information selected to be used as the ID for the second frame front the frame list. The converter 31 outputs to the selecting unit 23 the bits of the extracted frame following the bit string already output to the selecting unit 23.

While description has been made above regarding an example where the selecting unit 23 gives priority to smaller ID values, the frame selection method at the selecting unit 23 may be changed according to the implementation. For example, an arrangement may be made where the selecting unit 23 gives priority to larger ID values. The selecting unit 23 may also be set to give higher priority to frames from the control unit 30 as compared to frames from the CAN transceiver 21.

A processor may be included in the communication control device 20 or communication control device 60 as the selection circuit 101, processing circuit 102, and selection circuit 104. In this case, the processor reads out a program stored in the memory 103, and realizes the communication arbitration unit 22, selecting unit 23, and control unit 30 or control unit 50. The selection circuit 104 and the selection circuit 101 may be realized as a single circuit, or the selection circuit 104 and the processing circuit 102 may be realized as a single circuit.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication control device including a plurality of ports, the communication control device comprising:
a memory configured to store one or more pieces of identification information correlated with each of one or more of the plurality of ports to which a communication device has been coupled, the one or more pieces of identification information being included in a frame for transmission of the frame by one or more communication devices each coupled to the one or more ports;
a processor configured to generate a second frame in which is set second identification information regarding which determination will be made at the one or more communication devices that the frame is to be discarded, when first identification information in a first frame received at a first port of the one or more ports is not stored in the memory correlated with the first port; and
a selector configured to:
select only the second frame from among the first frame and the second frame when the first frame and the second frame are input, and
output the selected second frame to the plurality of ports.

2. The communication control device according to claim 1, wherein the processor is configured to:
acquire a signal input to the selector,
when it is determined that a first bit string from the first bit in the first identification information to a bit which is the object of comparison matches part of the identification information correlated to the first port, output to the selector a duplicate of the bit which is the object of comparison in the first frame as a bit in the second frame, and
when it is determined that the first bit string does not match any portion of identification information correlated with the first port, set, of the second identification information, the values of the second bit string not yet output to the selector, to values which is selected by the selector with priority over the values of the bits in the first identification information following the bit which is the object of comparison.

3. The communication control device according to claim 1, wherein
the memory is configured to store a list of identification information that will be determined to be the object of being discarded at the one or more communication devices, and
the processor is configured to select the second identification information from the identification information in the list.

4. The communication control device according to claim 1, wherein
the memory is configured to store a list of identification information that will be received by at least one of the one or more communication devices, and
the processor is configured to:
determine a first candidate as a candidate for the second identification information,
determine the first candidate as the second identification information when it is determined that the first candidate is not included in the list and is a value that is selected with priority by the selector over the first identification information,
generate a second candidate for the second identification information when it is determined that the first candidate is included in the list, and
determine whether the second candidate is included in the list.

5. The communication control device according to claim 2, wherein
the memory is configured to store a list of frames including identification information that will be determined to be the object of being discarded at the one of more communication devices,
the processor is configured to select the second frame from the frames in the list, and
the bits after the bit which is the object of comparison in the selected second frame are output to the selector.

6. A method of communicating a frame executed in a communication control device including a plurality of ports and a memory, the method comprising:
receiving a frame at a first port of the one or more ports;
determining whether first identification information in the first frame is not stored in the memory correlated with the first port, the memory storing one or more pieces of identification information correlated with each of one or more of the plurality of ports to which a communication device has been coupled, the one or more pieces of identification information being included in a frame for transmission of the frame by one or more communication devices each coupled to the one or more ports;
when it is determined that the first identification information in the first frame is not stored in the memory correlated with the first port, generating a second frame in which is set second identification information regarding which determination will be made at the one or more communication devices that the frame is to be discarded;
selecting, by a selector in the communication control device, only the second frame from among the first frame and the second frame when the first frame and the second frame are input to the selector; and
outputting the selected second frame to the plurality of ports.

7. The method according to claim 6, further comprising:
acquiring a signal input to the selector;
when it is determined that a first bit string from the first bit in the first identification information to a bit which is the object of comparison matches part of the identification information correlated to the first port, outputting to the selector a duplicate of the bit which is the object of comparison in the first frame as a bit in the second frame; and
when it is determined that the first bit string does not match any portion of identification information correlated with the first port, setting, of the second identification information, the values of the second bit string not yet output to the selector, to values which is selected by the selector with priority over the values of the bits in the first identification information following the bit which is the object of comparison.

8. The method according to claim 6, wherein
the memory is configured to store a list of identification information that will be determined to be the object of being discarded at the one or more communication devices, and
the method further includes:
selecting the second identification information from the identification information in the list.

9. The method according to claim 6, wherein
the memory is configured to store a list of identification information that will be received by at least one of the one or more communication devices, and
the method further includes:
determining a first candidate as a candidate for the second identification information;
determining the first candidate as the second identification information when it is determined that the first candidate is not included in the list and is a value that is selected with priority by the selector over the first identification information;
generating a second candidate for the second identification information when it is determined that the first candidate is included in the list; and
determining whether the second candidate is included in the list.

10. The method according to claim 7, wherein
the memory is configured to store a list of frames including identification information that will be determined to be the object of being discarded at the one of more communication devices, and
the method further includes:
selecting the second frame from the frames in the list; and
outputting, to the selector, the bits after the bit which is the object of comparison in the selected second frame.

11. A non-transitory computer-readable storage medium that stores a program for causing a communication control device including a plurality of ports and a memory to execute a process, the process comprising:
determining whether first identification information in a first frame received at a first port of the one or more ports is not stored in the memory correlated with the first port, the memory storing one or more pieces of identification information correlated with each of one or more of the plurality of ports to which a communication device has been coupled, the one or more pieces of identification information being included in a frame for transmission of the frame by one or more communication devices each coupled to the one or more ports; and
when it is determined that the first identification information in the first frame is not stored in the memory correlated with the first port, generating a second frame in which is set second identification information regarding which determination will be made at the one or more communication devices that the frame is to be discarded,
wherein
the second frame is only selected from among the first frame and the second frame when the first frame and the second frame are input to the selector, and
the selected second frame is output to the plurality of ports.

12. The non-transitory storage medium according to claim 11, wherein the process further comprising:
acquiring a signal input to the selector,
when it is determined that a first bit string from the first bit in the first identification information to a bit which is the object of comparison matches part of the identification information correlated to the first port, outputting to the selector a duplicate of the bit which is the object of comparison in the first frame as a bit in the second frame, and
when it is determined that the first bit string does not match any portion of identification information correlated with the first port, setting, of the second identification information, the values of the second bit string not yet output to the selector, to values which is selected by the selector with priority over the values of the bits in the first identification information following the bit which is the object of comparison.

13. The non-transitory storage medium according to claim 11, wherein
the memory is configured to store a list of identification information that will be determined to be the object of being discarded at the one or more communication devices, and
the process further includes:
selecting the second identification information from the identification information in the list.

14. The non-transitory storage medium according to claim 11, wherein
the memory is configured to store a list of identification information that will be received by at least one of the one or more communication devices, and
the process further includes:
determining a first candidate as a candidate for the second identification information,
determining the first candidate as the second identification information when it is determined that the first candidate is not included in the list and is a value that is selected with priority by the selector over the first identification information,
generating a second candidate for the second identification information when it is determined that the first candidate is included in the list, and
determining whether the second candidate is included in the list.

15. The non-transitory storage medium according to claim 12, wherein
the memory is configured to store a list of frames including identification information that will be determined to be the object of being discarded at the one of more communication devices, and
the process further includes:
selecting the second frame from the frames in the list; and
outputting, to the selector, the bits after the bit which is the object of comparison in the selected second frame.
